(19) United States
(12) Patent Application Publication
(10) Pub. No.: US 2025/0055934 A1
(43) Pub. Date: Feb. 13, 2025

(54) OPERATING METHOD FOR DETERMINING SCREEN DISPLAY MODE OF ELECTRONIC DEVICE, AND ELECTRONIC DEVICE

(71) Applicant: Samsung Electronics Co., Ltd., Suwon-si (KR)

(72) Inventors: Jinik KIM, Suwon-si (KR); Namjoon PARK, Suwon-si (KR); Seoyoung JIN, Suwon-si (KR)

(21) Appl. No.: 18/931,762

(22) Filed: Oct. 30, 2024

Related U.S. Application Data
(63) Continuation of application No. PCT/KR2023/004306, filed on Mar. 30, 2023.

(30) Foreign Application Priority Data
May 24, 2022 (KR) 10-2022-0063657
Jul. 13, 2022 (KR) 10-2022-0086518

(51) Int. Cl. H04M 1/72403; G06F 3/01; H04M 1/72454

(52) U.S. Cl. CPC H04M 1/72403; G06F 3/013; H04M 1/72454

(57) ABSTRACT

An electronic device including a display, a gyro-sensor, an acceleration sensor, a communication module, memory storing one or more computer programs, and one or more processors communicatively coupled to the display and the memory is provided. The one or more computer programs include computer-executable instructions that, when executed by the one or more processors individually or collectively, cause the electronic device to identify whether an automatic screen rotation function is activated, request an external electronic device to provide direction data of the external electronic device related to a degree of rotation of the external electronic device with regard to a designated axis through the communication module, thereby acquiring the direction data, identify a direction of the electronic device related to the degree of rotation of the electronic device with regard to a designated axis, based on values measured by the gyro sensor and the acceleration sensor, determine a user's posture, based on direction data of the electronic device and direction data of the external electronic device, and determine a screen direction mode to be displayed on the display of the electronic device, based on the user's posture.

### CROSS-REFERENCE TO RELATED APPLICATION(S)

This application is a continuation application, claiming priority under 35 U.S.C. § 365 (c), of an International application No. PCT/KR2023/004306, filed on Mar. 30, 2023, which is based on and claims the benefit of a Korean patent application number 10-2022-0063657, filed on May 24, 2022, in the Korean Intellectual Property Office, and of a Korean patent application number 10-2022-0086518, filed on Jul. 13, 2022, in the Korean Intellectual Property Office, the disclosure of each of which is incorporated by reference herein in its entirety.

### BACKGROUND

### 1. Field

The disclosure relates to an electronic device configured to determine the screen display mode of the electronic device, and a method for operating the electronic device. More particularly, the disclosure relates to determining the screen display mode of the electronic device, based on a user's posture.

### 2. Description of Related Art

Portable electronic devices have a display region configured in the shape of a rectangle having different horizontal and vertical lengths. Accordingly, portable terminals provide a screen rotation function to improve the efficiency of multimedia services.

An electronic device may be equipped with an automatic screen rotation function such that the screen rotates according to the direction of the electronic device. The automatic screen rotation function determines the direction of the electronic device by using sensing information from an inertial sensor included in the electronic device such that the screen is displayed in the horizontal or vertical mode according to the direction of the electronic device.

Specifically, if the automatic screen rotation function is activated, the electronic device may configure horizontal/vertical rotation thresholds according to the angle with reference to the gravitational direction, and may switch the screen if a change exceeding the angle occurs.

For example, if the portable terminal is rotated about 90° clockwise, the portable terminal may rotate the display direction of the display region about 90° counterclockwise.

The above information is presented as background information only to assist with an understanding of the disclosure. No determination has been made, and no assertion is made, as to whether any of the above might be applicable as prior art with regard to the disclosure.

### SUMMARY

In connection with the automatic screen rotation function, if the direction of the electronic device is solely considered, the screen is rotated unilaterally based on a quantitative amount of physical change, and such rotation may not be appropriate for some actual use cases. In addition, in connection with the automatic screen rotation function, the electronic device may fail to reflect the actual user's gaze angle information in the screen rotation.

Aspects of the disclosure are to address at least the above-mentioned problems and/or disadvantages and to provide at least the advantages described below. Accordingly, an aspect of the disclosure is to determine a user's posture based on the direction of an electronic device and the direction of an external electronic device (for example, a wearable device, wireless earphones, wireless headphones, or glasses, which may be worn).

Another aspect of the disclosure is to provide screen rotation according to the user's gaze by determining, based on the user's posture, how the user gazes at the screen of the electronic device, thereby enhancing the user's experience.

Additional aspects will be set forth in part in the description which follows and, in part, will be apparent from the description, or may be learned by practice of the presented embodiments.

In accordance with an aspect of the disclosure, an electronic device including a display, a gyro sensor, an acceleration sensor, a communication module, memory storing one or more computer programs, and one or more processors communicatively coupled to the display and the memory is provided. The one or more computer programs include computer-executable instructions that, when executed by the one or more processors individually or collectively, cause the electronic device to identify whether an automatic screen rotation function is activated, request an external electronic device to provide direction data of the external electronic device related to a degree of rotation of the external electronic device with regard to a designated axis through the communication module, thereby acquiring the direction data, identify a direction of the electronic device related to the degree of rotation of the electronic device with regard to a designated axis, based on values measured by the gyro sensor and the acceleration sensor, determine a user's posture, based on direction data of the electronic device and direction data of the external electronic device, and determine a screen direction mode to be displayed on the display of the electronic device, based on the user's posture.

In accordance with another aspect of the disclosure, a method for operating an electronic device is provided. The method includes identifying whether an automatic screen rotation function is activated, requesting an external electronic device to provide direction data of the external electronic device related to a degree of rotation of the external electronic device with regard to a designated axis, thereby acquiring the direction data, identifying a direction of the electronic device related to the degree of rotation of the electronic device with regard to a designated axis, based on values measured by a gyro sensor and an acceleration sensor, determining a user's posture, based on direction data of the electronic device and direction data of the external electronic device, and determining a screen direction mode to be displayed on a display of the electronic device, based on the user's posture.

In accordance with yet another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying whether an automatic screen rotation function is activated, requesting an external electronic device to provide direction data of the external electronic device related to a degree of rotation of the external electronic device with regard to a designated axis through a communication module, thereby acquiring the direction data, identifying a direction of the electronic device related to the degree of rotation of the electronic device with regard to a designated axis, based on values measured by a gyro sensor and an acceleration sensor, determining a user's posture, based on direction data of the electronic device and direction data of the external electronic device, and determining a screen direction mode to be displayed on the display of the electronic device, based on the user's posture.

According to various embodiments, the display direction mode of an electronic device is determined based on a user's posture.

According to various embodiments, screen rotation appropriate for the situation is provided by determining how the user gazes at the screen of the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A illustrates an electronic device and an external electronic device according to an embodiment of the disclosure;

FIG. 2B is a block diagram of an electronic device according to an embodiment of the disclosure;

FIG. 3 is a block diagram of an external electronic device according to an embodiment of the disclosure;

FIG. 4 is a flowchart illustrating a method in which an electronic device determines the display direction mode of the electronic device, based on the user's posture, according to an embodiment of the disclosure;

FIG. 5 is a flowchart illustrating a method in which an electronic device determines the display direction mode of the electronic device, based on the user's posture, according to an embodiment of the disclosure;

FIG. 6 illustrates an example for describing a method in which an electronic device determines the user's posture, based on the direction of the electronic device and the direction of an external electronic device, according to an embodiment of the disclosure;

FIGS. 7A and 7B illustrate an embodiment in which an electronic device determines the display direction of the electronic device, based on the user's posture, according to various embodiments of the disclosure;

FIG. 8 illustrates the configuration of an external electronic device according to an embodiment of the disclosure; and

FIG. 9 illustrates the configuration of an external electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

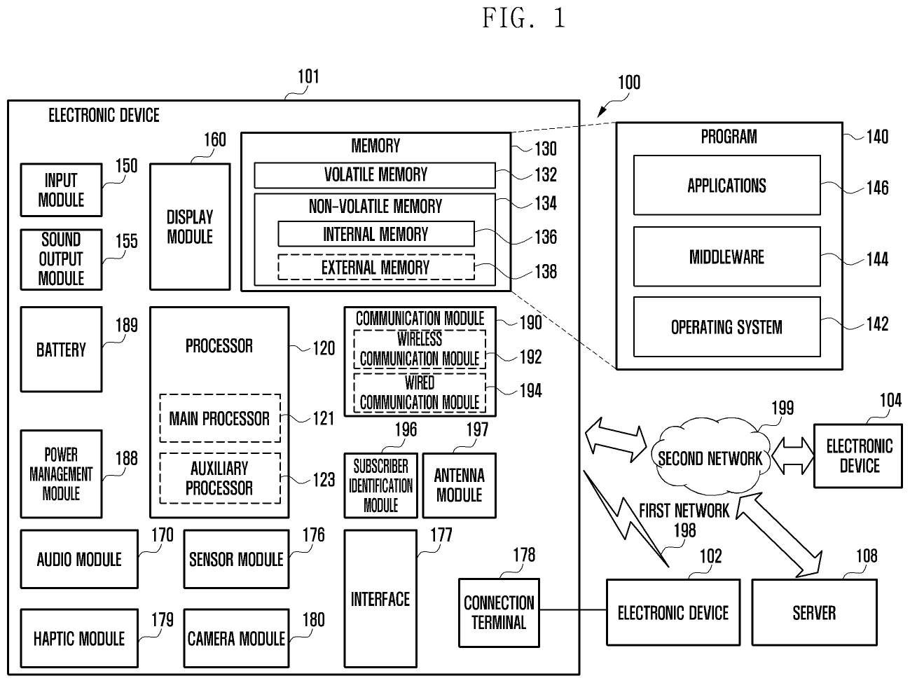

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display 1 module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the 11 connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160). 11

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display 1 module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display 1 module 160 may visually provide information to the outside (e.g., a user) of the electronic device 101. The display 1 module 160 may include, for example, a display, a hologram device, or a projector and control circuitry to control a corresponding one of the display, hologram device, and projector. According to an embodiment, the display 1 module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

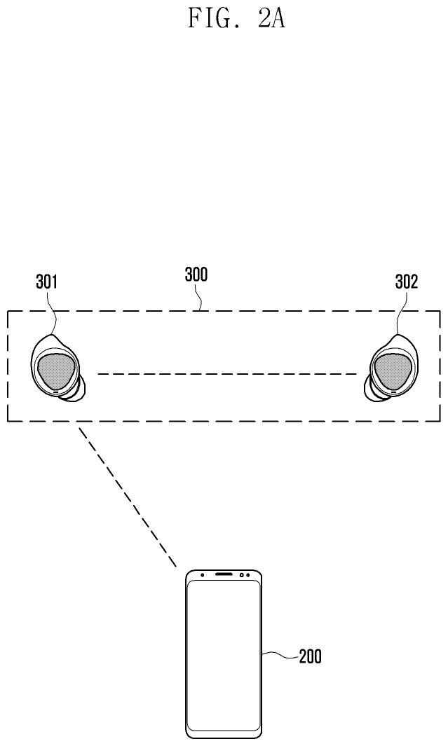

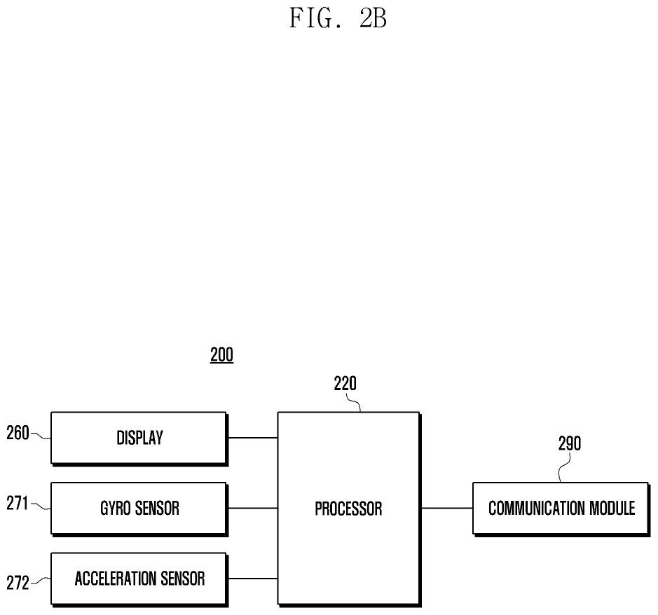

FIG. 2A illustrates an electronic device 200 and an external electronic device 300 according to an embodiment of the disclosure.

According to various embodiments, the electronic device 200 (for example, the electronic device 101 in FIG. 1) may include the components illustrated in FIG. 2B.

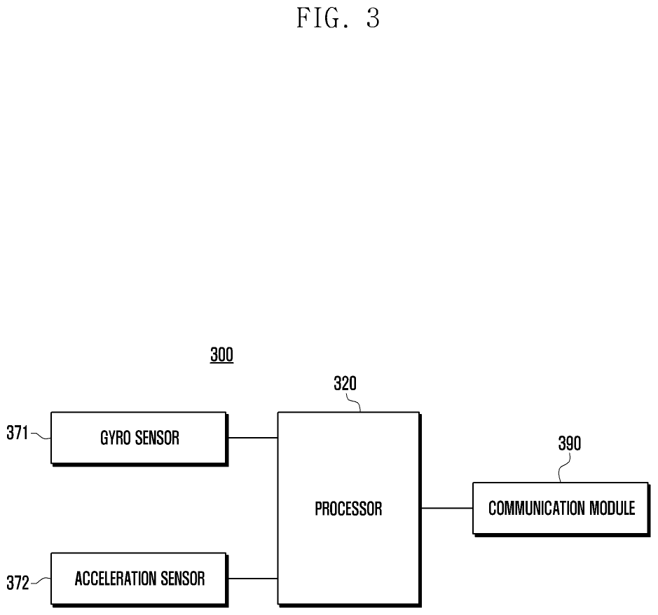

According to various embodiments, the external electronic device 300 (for example, the electronic device 102 and/or the electronic device 104 in FIG. 1) may include a first external electronic device 300 unit 301 and/or a second external electronic device 300 unit 302, and each unit may include the components illustrated in FIG. 3.

According to an embodiment, the first external electronic device 300 unit 301 and the second external electronic device 300 unit 302 may be paired with each other through respective communication modules, thereby transmitting/receiving data.

According to an embodiment, one of the first external electronic device 300 unit 301 and the second external electronic device 300 unit 302 may be a primary unit, and the other may be a secondary unit. The primary unit may transmit/receive data with the electronic device 200, and the secondary unit may acquire data from the primary unit.

According to an embodiment, each of the first external electronic device 300 unit 301 and the second external electronic device 300 unit 302 may be connected to the electronic device 200 so as to transmit/receive data.

According to various embodiments, the electronic device 200 and the external electronic device 300 may transmit/receive data with each other through communication modules (for example, the communication module 290 in FIG. 2B and the communication module 390 in FIG. 3).

According to an embodiment, the electronic device 200 may transmit a message requesting direction data of the external electronic device 300 to the primary unit of the external electronic device 300 through the communication module 290. According to an embodiment, the primary unit of the external electronic device 300 may transmit direction data of the external electronic device 300 to the electronic device 200 through the communication module 390.

Operations of the external electronic device 300 described herein may correspond to operations of only the primary unit among the first external electronic device 300 unit 301 and the second external electronic device 300 unit 302.

FIG. 2B is a block diagram of an electronic device according to an embodiment of the disclosure.

Referring to FIG. 2B, the electronic device 200 (for example, the electronic device 101 in FIG. 1) may include a processor 220 (for example, the processor 120 in FIG. 1), a display 260 (for example, the display module 160 in FIG. 1), a gyro sensor 271, an acceleration sensor 272 (for example, the sensor module 176 in FIG. 1), and/or a communication module 290 (for example, the communication module 190 in FIG. 1). The components illustrated in FIG. 2B are some of the components included in the electronic device 200, and the electronic device 200 may include various other components as illustrated in FIG. 1.

According to various embodiments, the gyro sensor 271 may measure the angular velocity of the electronic device 200 with regard to a designated axis. For example, the gyro sensor 271 may convert the Coriolis force generated by a rotational movement of the electronic device 200 to an electric signal, thereby calculating the angular velocity. For example, the gyro sensor 271 may measure the angular velocity of the electronic device 200 with regard to each of the x, y, and z axes.

According to various embodiments, the acceleration sensor 272 may measure the gravitational acceleration regarding the electronic device 200 and/or accelerations generated by respective changes in the magnitude and direction of the velocity thereof.

According to various embodiments, the processor 220 may calculate the direction of the electronic device 200, which corresponds to the angle of rotation with reference to a designated axis, based on data measured by the gyro sensor 271 and the acceleration sensor 272. According to an embodiment, the processor 220 of the electronic device 200 may be configured by multiple processor modules (for example, first and second processor modules), and the multiple processor modules may perform divided parts of a data operation or data processing, respectively.

According to various embodiments, the communication module 290 may communicate with the external electronic device 300 through a network (for example, the first network 198 and/or the second network 199 in FIG. 1) so as to receive and/or transmit various pieces of information. The processor 220 may be connected to the communication module 290 electrically and/or operatively so as to process various pieces of information which the communication module 290 has received from the external electronic device 300. In addition, the processor 220 may control the communication module 290 so as to transmit various pieces of information to the external electronic device 300. For example, the communication module may request the external electronic device 300 to provide direction information of the external electronic device 300 by means of the processor 220 and/or may receive direction data of the external electronic device 300 from the external electronic device 300.

According to various embodiments, the display 260 may visually display various pieces of information by means of the processor 220. For example, the display 260 may display a screen in the vertical or horizontal mode, based on a mode determined by the processor 220.

FIG. 3 is a block diagram of an external electronic device according to an embodiment of the disclosure.

Referring to FIG. 3, the external electronic device 300 (for example, the electronic device 102 and/or the electronic device 104 in FIG. 1) may include a processor 320, a gyro sensor 371, an acceleration sensor 372, and/or a communication module 390. The components illustrated in FIG. 3 are some of the components included in the external electronic device 300, and the external electronic device 300 may include various other components as illustrated in FIG. 1.

According to various embodiments, the structure illustrated in FIG. 3 may be a structure included in the first external electronic device 300 unit 301 and/or the second external electronic device 300 unit 302 in FIG. 2A.

According to various embodiments, the gyro sensor 371 may measure the angular velocity of the external electronic device 300 with regard to a designated axis. For example, the gyro sensor 371 may convert the Coriolis force generated by a rotational movement of the external electronic device 300 to an electric signal, thereby calculating the angular velocity. For example, the gyro sensor 371 may measure the angular velocity of the external electronic device 300 with regard to each of the x, y, and z axes.

According to various embodiments, the acceleration sensor 372 may measure the gravitational acceleration regarding the external electronic device 300 and/or accelerations generated by respective changes in the magnitude and direction of the velocity thereof.

According to various embodiments, the processor 320 may calculate the direction of the external electronic device 300, which corresponds to the angle of rotation with reference to a designated axis, based on data measured by the gyro sensor 371 and the acceleration sensor 372. According to an embodiment, the processor 320 of the external electronic device 300 may be configured by multiple processor modules (for example, third and fourth processor modules), and the multiple processor modules may perform divided parts of a data operation or data processing, respectively.

According to various embodiments, the communication module 390 may communicate with the electronic device 200 through a network (for example, the first network 198 and/or the second network 199 in FIG. 1) so as to receive and/or transmit various pieces of information. The processor 320 may control the communication module 390 so as to transmit various pieces of information to the electronic device 200. For example, the communication module 390 may receive a request for direction data of the external electronic device 300 from the electronic device, or may transmit direction information of the external electronic device 300 to the electronic device 200 by means of the processor 320.

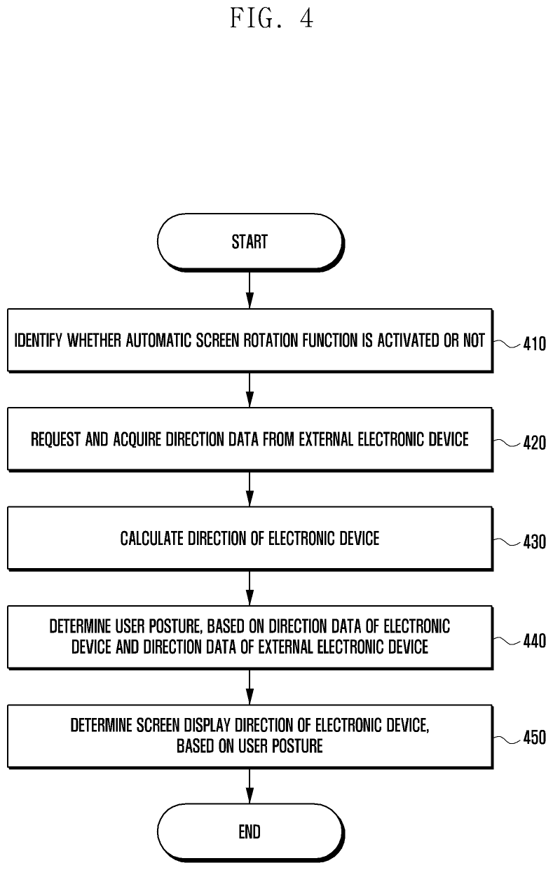

FIG. 4 is a flowchart illustrating a method in which an electronic device determines the display direction mode of the electronic device, based on the user's posture, according to an embodiment of the disclosure.

The embodiment illustrated in FIG. 4 is only an example, the order of operations according to various embodiments disclosed herein may differ from that illustrated in FIG. 4, some operations illustrated in FIG. 4 may be omitted, the order of operations may be changed, or operations may be merged.

According to various embodiments, the processor 220 (for example, the processor 120 in FIG. 1 and/or the processor 220 in FIG. 2B) may identify whether an automatic screen rotation function is activated or not in operation 410.

According to an embodiment, the automatic screen rotation function may display the screen in a vertical mode and/or a horizontal mode according to the direction of the electronic device 200 (for example, the electronic device 101 in FIG. 1 and/or the electronic device 200 in FIGS. 2A and 2B) and/or the user's posture.

The processor 220 may perform operations 420 to 450 in response to the automatic screen rotation function being activated.

According to various embodiments, the processor 220 may request the external electronic device 300 (for example, the electronic device 102, the electronic device 104 in FIG. 1, the external electronic device 300 in FIG. 2A, and/or the external electronic device 300 in FIG. 3) to provide direction data, thereby acquiring the same, in operation 420.

According to an embodiment, the processor 220 may identify whether the external electronic device 300 is connected or not. For example, the processor 220 may identify whether the same is connected to the external electronic device 300 or not through the communication module 290 (for example, the communication module 190 in FIG. 1 and/or the communication module 290 in FIG. 2B). For example, the processor 220 may identify whether the communication module 290 of the electronic device 200 and the communication module 390 (for example, the communication module 390 in FIG. 3) of the external electronic device 300 are connected such that data can be exchanged.

According to an embodiment, the processor 220 may request the external electronic device 300 to provide direction data in response to identifying connection to the external electronic device 300. For example, the processor 220 may transmit a message requesting direction data to the external electronic device 300 through the communication module 290. According to an embodiment, the processor 220 may request the external electronic device 300 to transmit direction data of the external electronic device 300 at a designated timepoint. For example, the processor 220 may request the external electronic device 300 to transmit direction data of the external electronic device 300 at a designated timepoint from activation of the automatic screen rotation function to deactivation thereof.

According to an embodiment, the processor 220 may acquire direction data of the external electronic device 300 from the external electronic device 300 through the communication module 290. According to an embodiment, the processor 220 may acquire direction data of the external electronic device 300 from the external electronic device 300 at each designated timepoint.

According to various embodiments, the processor 220 may calculate the direction of the electronic device 200 in operation 430.

According to an embodiment, the processor 220 may calculate the direction of the electronic device 200, which corresponds to the angle of rotation with reference to a designated axis, based on data measured by the gyro sensor 271 (for example, the gyro sensor 271 in FIG. 2B) and the acceleration sensor 272 (for example, the acceleration sensor 272 in FIG. 2B).

The acceleration sensor 272 may measure the gravitational acceleration regarding the electronic device 200 and/or accelerations generated by respective changes in the magnitude and direction of the velocity thereof. The gyro sensor 271 may measure the angular velocity of the electronic device 200 with regard to a designated axis.

According to various embodiments, the processor 220 may determine the user's posture, based on direction data of the electronic device 200 and direction data of the external electronic device 300, in operation 440.

According to an embodiment, the processor 220 may convert the direction of the external electronic device 300 acquired from the external electronic device 300, in response to the same being in the Euler angle format (angles of rotation around respective axes of the Cartesian coordinate system), to the quaternion format (vector format). The processor 220 may then convert the user's head direction according to the coordinate system of the external electronic device 300 to the user's head direction according to a geographic coordinate system, by using the direction of the external electronic device according to the geographic coordinate system.

According to an embodiment, the processor 220 may convert the user's head direction corresponding to the coordinate system of the external electronic device 300 to the user's head direction according to the geographic coordinate system by using the direction of the external electronic device according to the geographic coordinate system, in response to the direction of the external electronic device 300 acquired from the external electronic device 300 being in the quaternion format. For example, the user's head direction may indicate the y-axis direction according to the coordinate system of the external electronic device. According to an embodiment, a gaze vector corresponding to the y-axis of the user's head direction may be converted to a gaze vector according to the geographic coordinate system by using the user's head direction according to the geographic coordinate system.

According to an embodiment, the processor 220 may determine the user's posture, based on the direction of the electronic device 200 and the user's gaze vector.

For example, the processor 220 may convert a gaze vector according to the quaternion-format geographic coordinate system to the Euler format.

For example, the processor 220 may determine the field of view (FOV) of the electronic device 200, based on the Euler angle of each axis of the direction of the electronic device 200, and may determine the FOV of the user gaze, based on the Euler angle of each axis of the gaze vector. The processor 220 may determine that the user's posture is a first posture in response to the region in which the FOV of the electronic device 200 and the FOV of the user gaze coincide being in a first range. The first posture may refer to a posture in which the user gazes at the electronic device 200 in the vertical direction.

For example, the processor 220 may determine that the user's posture is a second posture in response to the region in which the FOV of the electronic device 200 and the FOV of the user gaze coincide being in a second range different from the first range. The second posture may refer to a posture in which the user gazes at the electronic device 200 in the horizontal direction.

According to various embodiments, the processor 220 may determine the screen display direction of the electronic device 200, based on the user posture, in operation 450.

According to an embodiment, the processor 220 may determine the screen display direction of the electronic device 200, based on the user posture determined in operation 440.

For example, the screen of the electronic device 200 may be displayed in the vertical mode on the display 260 (for example, the display module 160 in FIG. 1 and/or the display 260 in FIG. 2B) in response to the user's posture being the first posture. For example, the electronic device 200 may display the screen of the electronic device 200 in the horizontal mode on the display 260 in response to the user's posture being the second posture.

According to an embodiment, the processor 220 may determine whether or not to change the screen display direction of the electronic device 200, based on a change in the direction of the electronic device 200 and/or the gaze vector, after determining the screen display direction of the electronic device 200, based on the user's posture determined in operation 440.

For example, the processor 220 may not change the screen display direction of the electronic device 200, in response to the direction of the electronic device 200 not being changed, and the gaze vector being changed.

For example, the processor 220 may change the screen display direction of the electronic device 200, based on the user posture, in response to the direction of the electronic device 200 being changed, and the gaze vector not being changed.

For example, the processor 220 may change the screen display direction of the electronic device 200, based on the user posture, in response to the direction of the electronic device 200 being changed, and the gaze vector being changed.

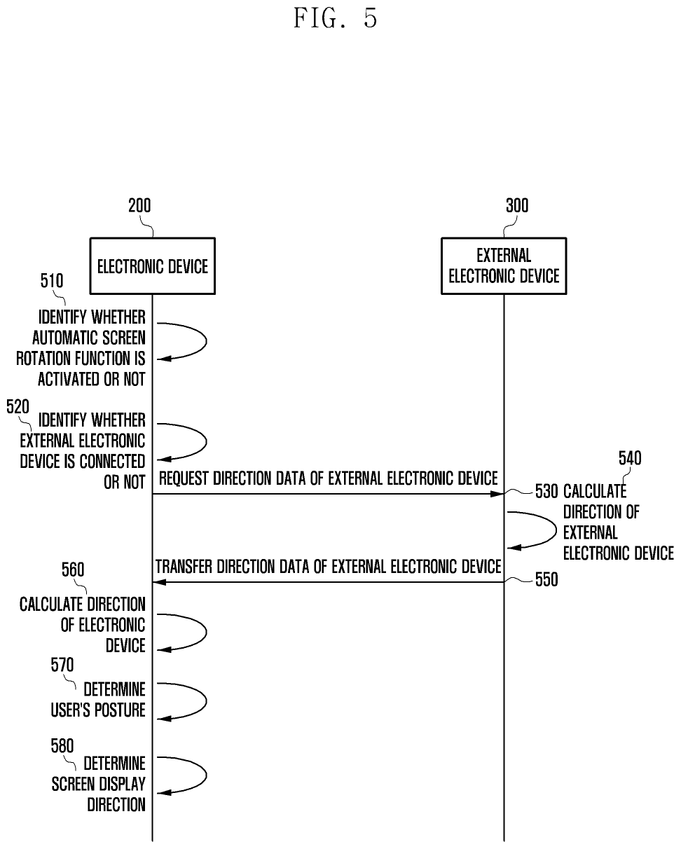

FIG. 5 is a flowchart illustrating a method in which an electronic device determines the display direction mode of the electronic device, based on the user's posture, according to an embodiment of the disclosure.

The embodiment illustrated in FIG. 5 is only an example, the order of operations according to various embodiments disclosed herein may differ from that illustrated in FIG. 5, some operations illustrated in FIG. 5 may be omitted, the order of operations may be changed, or operations may be merged.

According to an embodiment, operations 510 to 580 may be understood as being performed by the processor (for example, the processor 220 in FIG. 2B or the processor 320 in FIG. 3) of each electronic device (for example, the electronic device 200 or the external electronic device 300).

According to various embodiments, the electronic device 200 (for example, the electronic device 101 in FIG. 1 and/or the electronic device 200 in FIGS. 2A and 2B) may identify whether an automatic screen rotation function is activated or not in operation 510.

According to an embodiment, the automatic screen rotation function may display the screen in a vertical mode and/or a horizontal mode according to the direction of the electronic device 200 and/or the user's posture.

The electronic device 200 may perform operations 520 to 580 in response to the automatic screen rotation function being activated.

According to various embodiments, the electronic device 200 may identify whether an external electronic device 300 (for example, the electronic device 102, the electronic device 104 in FIG. 1, the external electronic device 300 in FIG. 2A, and/or the external electronic device 300 in FIG. 3) is connected or not in operation 520.

According to an embodiment, the electronic device 200 may identify whether the same is connected to the external electronic device 300 through the communication module 290 (for example, the communication module 190 in FIG. 1 and/or the communication module 290 in FIG. 2B). For example, the electronic device 200 may identify whether the communication module 290 of the electronic device 200 and the communication module 390 (for example, the communication module 390 in FIG. 3) of the external electronic device 300 are connected or not such that data can be exchanged.

The electronic device 200 may perform operation 530 in response to identifying connection to the external electronic device 300.

According to various embodiments, the electronic device 200 may request the external electronic device 300 to provide direction data in operation 530.

According to an embodiment, the electronic device 200 may request the external electronic device 300 to provide direction data in response to identifying connection to the external electronic device 300. For example, the electronic device 200 may transmit a message requesting direction data to the external electronic device 300 through the communication module 290.

According to an embodiment, the electronic device 200 may request the external electronic device 300 to transmit direction data of the external electronic device 300 at a designated timepoint. For example, the electronic device 200 may request the external electronic device 300 to transmit direction data of the external electronic device 300 at a designated timepoint from activation of the automatic screen rotation function to deactivation thereof.

According to various embodiments, the external electronic device 300 may calculate the direction of the external electronic device 300 in operation 540.

According to an embodiment, the external electronic device 300 may calculate the direction of the external electronic device 300, based on data measured by the gyro sensor 371 (for example, the gyro sensor 371 in FIG. 3) and the acceleration sensor 372 (for example, the acceleration sensor 372 in FIG. 3).

The acceleration sensor 372 of the external electronic device 300 may measure the gravitational acceleration regarding the external electronic device 300 and/or accelerations generated by respective changes in the magnitude and direction of the velocity thereof. The gyro sensor 371 of the external electronic device 300 may measure the angular velocity of the external electronic device 300 with regard to a designated axis.

The processor 320 of the external electronic device 300 may calculate the direction of the external electronic device 300, which corresponds to the angle of rotation with reference to a designated axis, based on data measured by the gyro sensor 371 and the acceleration sensor 372.

According to various embodiments, the external electronic device 300 may transmit direction data to the electronic device 200 in operation 550.

According to an embodiment, the external electronic device 300 may transmit direction data of the external electronic device 300 identified in operation 540 to the electronic device 200. For example, the external electronic device 300 may transmit direction data of the external electronic device 300 to the electronic device 200 through the communication module 390.

According to an embodiment, the external electronic device 300 may transmit the direction of the external electronic device 300 to the electronic device 200 in the Euler angle format and/or the quaternion format.

According to an embodiment, the external electronic device 300 may transmit direction data to the electronic device 200 at a designated timepoint from the time of request for data transmission by the electronic device 200 to the time of request for transmission suspension, in response to the electronic device 200 requesting transmission of direction data at a designated timepoint.

According to an embodiment, the electronic device 200 may acquire direction data of the external electronic device 300 from the external electronic device 300 through the communication module 290.

According to an embodiment, the electronic device 200 may acquire direction data of the external electronic device 300 from the external electronic device 300 at each designated timepoint.

According to various embodiments, the electronic device 200 may calculate the direction of the electronic device 200 in operation 560.

According to an embodiment, the electronic device 200 may calculate the direction of the electronic device 200, based on data measured by the gyro sensor 271 (for example, the gyro sensor 271 in FIG. 2B) and the acceleration sensor 272 (for example, the acceleration sensor 272 in FIG. 2B).

The acceleration sensor 272 of the electronic device 200 may measure the gravitational acceleration regarding the electronic device 200 and/or accelerations generated by respective changes in the magnitude and direction of the velocity thereof. The gyro sensor 271 of the electronic device 200 may measure the angular velocity of the electronic device 200 with regard to a designated axis.

The processor 220 of the electronic device 200 may calculate the direction of the electronic device 200, which corresponds to the angle of rotation with reference to a designated axis, based on data measured by the gyro sensor 271 and the acceleration sensor 272.

According to various embodiments, the electronic device 200 may determine the user posture in operation 570.

According to an embodiment, the electronic device 200 may convert the direction of the external electronic device 300 acquired from the external electronic device 300, in response to the same being in the Euler angle format (angles of rotation around respective axes of the Cartesian coordinate system), to the quaternion format (vector format). The electronic device 200 may then convert the user's head direction according to the coordinate system of the external electronic device 300 to the user's head direction according to a geographic coordinate system, by using the direction of the external electronic device according to the geographic coordinate system.

According to an embodiment, the electronic device 200 may convert the user's head direction corresponding to the coordinate system of the external electronic device 300 to the user's head direction according to the geographic coordinate system by using the direction of the external electronic device according to the geographic coordinate system, in response to the direction of the external electronic device 300 acquired from the external electronic device 300 being in the quaternion format.

According to an embodiment, a gaze vector (for example, the y-axis) of the user's head direction may be converted to a gaze vector according to the geographic coordinate system by using the user's head direction according to the geographic coordinate system.

According to an embodiment, the electronic device 200 may determine the user's posture, based on the direction of the electronic device 200 and the user's gaze vector.

For example, the electronic device 200 may convert a gaze vector according to the quaternion-format geographic coordinate system to the Euler format.

For example, the electronic device 200 may determine the field of view (FOV) of the electronic device 200, based on the Euler angle of each axis of the direction of the electronic device 200, and may determine the FOV of the user gaze, based on the Euler angle of each axis of the gaze vector. The processor 220 may determine that the user's posture is a first posture in response to the region in which the FOV of the electronic device 200 and the FOV of the user gaze coincide being in a first range. The first posture may refer to a posture in which the user gazes at the electronic device 200 in the vertical direction.

For example, the electronic device 200 may determine that the user's posture is a second posture in response to the region in which the FOV of the electronic device 200 and the FOV of the user gaze coincide being in a second range different from the first range. The second posture may refer to a posture in which the user gazes at the electronic device 200 in the horizontal direction.

According to various embodiments, the electronic device 200 may determine the screen display direction of the electronic device 200, based on the user posture, in operation 580.

According to an embodiment, the electronic device 200 may determine the screen display direction of the electronic device 200, based on the user's posture determined in operation 570.

For example, the screen of the electronic device 200 may be displayed in the vertical mode on the display 260 (for example, the display module 160 in FIG. 1 and/or the display 260 in FIG. 2B) in response to the user's posture being the first posture. For example, the electronic device 200 may display the screen of the electronic device 200 in the horizontal mode on the display 260 in response to the user's posture being the second posture.

According to an embodiment, the electronic device 200 may determine whether or not to change the screen display direction of the electronic device 200, based on a change in the direction of the electronic device 200 and/or the gaze vector, after determining the screen display direction of the electronic device 200, based on the user's posture determined in operation 570.

For example, the electronic device 200 may not change the screen display direction of the electronic device 200, in response to the direction of the electronic device 200 not being changed, and the gaze vector being changed.

For example, the electronic device 200 may change the screen display direction of the electronic device 200, based on the user posture, in response to the direction of the electronic device 200 being changed, and the gaze vector not being changed.

For example, the electronic device 200 may change the screen display direction of the electronic device 200, based on the user posture, in response to the direction of the electronic device 200 being changed, and the gaze vector being changed.

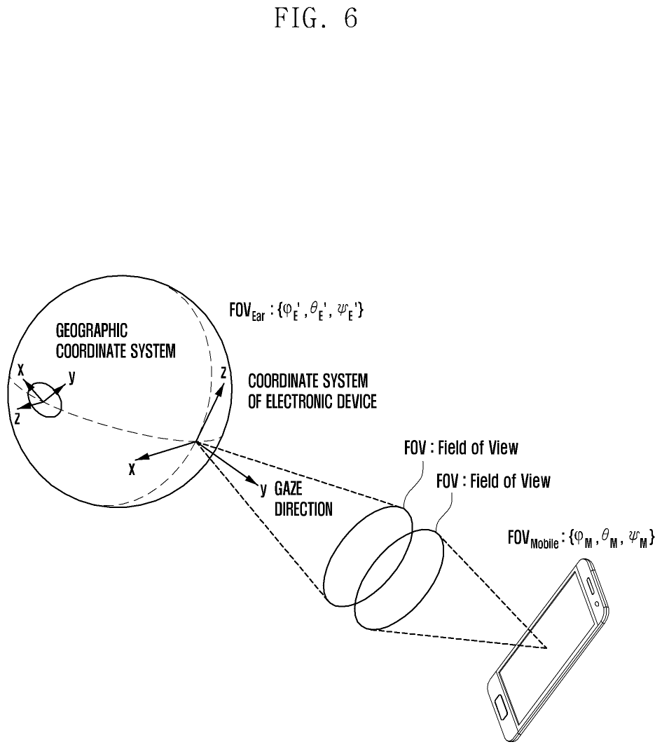

FIG. 6 illustrates an example for describing a method in which an electronic device (for example, the electronic device 200 in FIG. 2B) determines the user's posture, based on the direction of the electronic device and the direction of an external electronic device (for example, the external electronic device 300 in FIG. 3), according to an embodiment of the disclosure.

According to various embodiments, the electronic device 200 may determine the direction (Euler angles φ_{M}, θ_{M}, ψ_{M}) of the electronic device, based on data (accelerations fₓ, f_{y}, f_{z}) measured by the acceleration sensor 272 (for example, the acceleration sensor 272 in FIG. 2B) and data (angular velocities p, q, r) measured by the gyro sensor 271 (for example, the gyro sensor 271 in FIG. 2B).

According to an embodiment, the acceleration sensor 272 may measure the gravitational acceleration regarding the electronic device 200 and/or various accelerations (fₓ, f_{y}, f_{z}) generated by respective changes in the magnitude and direction of the velocity thereof.

Equation 1 describes the characteristics of accelerations (fₓ, f_{y}, f_{z}) measured by the acceleration sensor 272.

$$[ \begin{matrix}{f}_{x} \\ {f}_{y} \\ {f}_{x}\end{matrix} ] = [ \begin{matrix}{v}_{x}^{*} \\ {v}_{y}^{*} \\ {v}_{z}^{*}\end{matrix} ] + [ \begin{matrix}0 & {v}_{z} & - {v}_{y} \\ - {v}_{z} & 0 & {v}_{x} \\ {v}_{y} & - {v}_{x} & 0\end{matrix} ] [ \begin{matrix}{ω}_{x} \\ {ω}_{y} \\ {ω}_{z}\end{matrix} ] + g [ \begin{matrix}sin θ \\ - cos θsin ϕ \\ - cos θcos ϕ\end{matrix} ] \qquad Equation 1$$

Equation 1 above is only an example for helping understanding, is not limitative, and may be variously modified, applied, or expanded.

In Equation 1, (vₓ, v_{y}, v_{z}) may refer to translational velocities, (ωₓ, ω_{y}, ω_{z}) may refer to rotational angular velocities, g may refer to the gravitational acceleration, q may refer to the angle of rotation around the x-axis (pitch), and θ may refer to the angle of rotation around the y-axis (roll).

In the case of a stationary state or a constant-velocity movement of the electronic device 200, Equation 1 may be simplified to Equation 2.

$$[ \begin{matrix}{f}_{x} \\ {f}_{y} \\ {f}_{x}\end{matrix} ] = g [ \begin{matrix}sin θ \\ - cos θsin ϕ \\ - cos θcos ϕ\end{matrix} ] \qquad Equation 2$$

By arranging Equation 2, roll (θ) and pitch (φ) angles may be calculated based on accelerations (fₓ, f_{y}, f_{z}) as in Equation 3.

$$θ = {sin}^{- 1} ( \frac{{f}_{x}}{g} ) \qquad Equation 3$$

$$ϕ = {sin}^{- 1} ( \frac{- {f}_{x}}{g cos θ} )$$

According to an embodiment, the gyro sensor 271 may measure angular velocities (p, q, r) of the electronic device with regard to respective axes (x, y, z).

Equation 4 calculates the direction of the electronic device 200 (for example, Euler angles, the rotation (pitch φ) around the x-axis, the rotation (roll θ) around the y-axis, the rotation (yaw ψ) around the z-axis), based on acceleration-based roll (θ) and pitch (q) angles and angular velocities (p, q, r).

$$[ \begin{matrix}ϕ \\ θ \\ ψ\end{matrix} ] = [ \begin{matrix}1 & sin ϕ tan θ & cos ϕtan θ \\ 0 & cos ϕ & - sin ϕ \\ 0 & sin ϕ / cos θ & cos ϕ / cos θ\end{matrix} ] [ \begin{matrix}p \\ q \\ r\end{matrix} ] \qquad Equation 4$$

According to various embodiments, the external electronic device 300 may determine the direction (φ_{E}, θ_{E}, ψ_{E}) of the external electronic device 300, based on data (accelerations fₓ, f_{y}, f_{z}) measured by the acceleration sensor 372 in the same method as above, and data (angular velocities p, q, r) measured by the gyro sensor 371.

According to various embodiments, the external electronic device 300 may convert the direction (φ_{E}, θ_{E}, ψ_{E}) of the external electronic device 300 from the Euler angle format to the quaternion format (q⁰_{E}, q¹_{E}, q²_{E}, q³_{E}) and may transmit the same to the electronic device 200.

Equation 5 describes the relationship between Euler angles (φ, θ, ψ) and quaternions (q0, q1, q2, q3).

$$q 0 = cos ( ϕ / 2 ) cos ( θ / 2 ) cos ( ψ / 2 ) + sin ( ϕ / 2 ) sin ( θ / 2 ) sin ( ψ / 2 ) \qquad Equation 5$$

$$q 1 = sin ( ϕ / 2 ) cos ( θ / 2 ) cos ( ψ / 2 ) - cos ( ϕ / 2 ) sin ( θ / 2 ) sin ( ψ / 2 )$$

$$q 2 = cos ( ϕ / 2 ) sin ( θ / 2 ) cos ( ψ / 2 ) + sin ( ϕ / 2 ) cos ( θ / 2 ) sin ( ψ / 2 )$$

$$q 3 = cos ( ϕ / 2 ) cos ( θ / 2 ) cos ( ψ / 2 ) - sin ( ϕ / 2 ) sin ( θ / 2 ) sin ( ψ / 2 )$$

According to various embodiments, the electronic device 200 may convert the user's head direction according to the coordinate system of the external electronic device to the user's head direction according to a geographic coordinate system by using the direction of the external electronic device according to the geographic coordinate system.

Equation 6 converts the user's head direction corresponding to the coordinate system of the external electronic device 300 to the user's head direction according to a geographic coordinate system through coordinate system conversion using quaternions.

$${q}_{H}^{N} = {q}_{E}^{N} \cdot {q}_{H}^{E} \qquad Equation 6$$

wherein q^{N}_{E} may refer to the direction of the external electronic device 300 (earbuds) with reference to a geographic coordinate system (navigation frame), q^{N}_{H} may refer to the user's head direction according to the geographic coordinate system, and q^{E}_{H} may refer to the user's head direction corresponding to the coordinate system of the external electronic device 300.

Equation 7 may convert a gaze vector along the y-axis in the user's head direction to a gaze vector according to the geographic coordinate system by using the user's head direction according to the geographic coordinate system.

$${V}^{′} = {q}_{H}^{N} \cdot V \cdot {( {q}_{H}^{N} )}^{- 1} \qquad Equation 7$$

wherein V may refer to a gaze direction vector in the user's head direction (with reference to the coordinate system of the external electronic device), and V′ may refer to a gaze direction vector according to the geographic coordinate system.

According to various embodiments, the electronic device 200 may determine the user's posture, based on a gaze vector according to the geographic coordinate system. According to various embodiments, the electronic device 200 may convert the gaze vector (V′) according to the geographic coordinate system from the quaternion format (q^{0′}_{E}, q^{1′}_{E}, q^{2′}_{E}, q^{3′}_{E}) to the Euler angle format (φ′_{E}, θ′_{E}, ψ′_{E}).

According to various embodiments, the electronic device 200 may determine the user's posture, based on the gaze vector direction (φ′_{E}, θ′_{E}, ψ′_{E}) according to the geographic coordinate system and the direction (φ_{M}, θ_{M}, ψ_{M}) of the electronic device 200.

For example, the electronic device 200 may determine the user's posture according to the degree of coincidence between respective (φ, θ, ψ) values of the gaze vector direction (φ′_{E}, θ′_{E}, ψ′_{E}) according to the geographic coordinate system and the direction (φ_{M}, θ_{M}, ψ_{M}) of the electronic device 200.

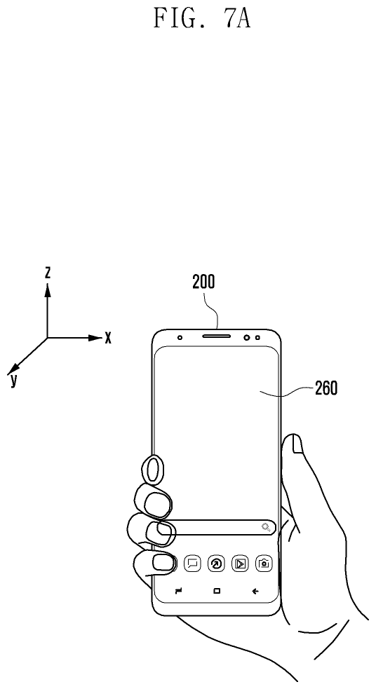

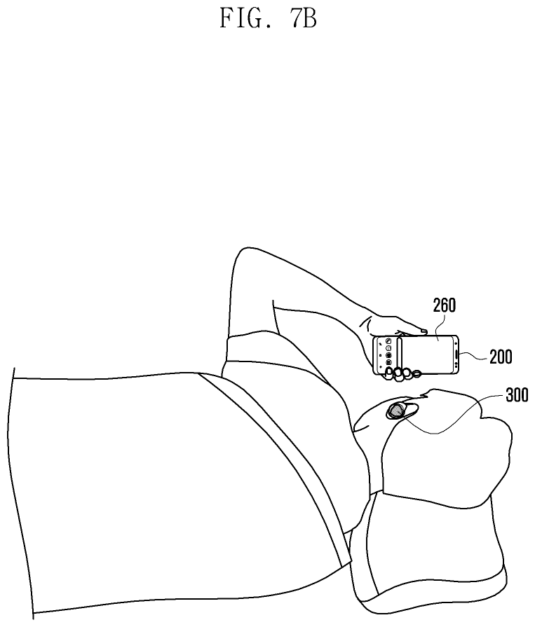

FIGS. 7A and 7B illustrate an embodiment in which an electronic device determines the display direction of the electronic device, based on the user's posture, according to various embodiments of the disclosure.

FIG. 7A may be an example of a screen displayed on the display 260 (for example, the display module 160 in FIG. 1 and/or the display 260 in FIG. 2B) when the electronic device 200 (for example, the electronic device 101 in FIG. 1 and/or the electronic device 200 in FIGS. 2A and 2B) is in a vertical mode. If the user holds the electronic device 200 in the vertical direction, the electronic device 200 may display a screen on the display 260 in the vertical mode as in FIG. 7A.

FIG. 7B is an example in which the electronic device 200 displays a screen according to the user posture when an automatic screen switching mode is activated.

Referring to FIG. 7B, if the user holds the electronic device 200 in the vertical direction in a horizontally lying posture while wearing an external electronic device 300 (for example, the electronic device 102, the electronic device 104 in FIG. 1, the external electronic device 300 in FIG. 2A, and/or the external electronic device 300 in FIG. 3), the user may gaze at the electronic device 200 in the vertical direction. If the automatic screen switching mode is activated, the electronic device 200 may determine the user's posture, based on the direction of the external electronic device 300 and the direction of the electronic device 200. In the case of FIG. 7B, the electronic device 200 may determine that the user's posture is a first posture, in response to the direction of the external electronic device 300 and the direction of the electronic device 200 coinciding, and may display a screen on the display 260 in the vertical mode.

According to various embodiments, the display direction mode of the electronic device may be determined based on the user's posture.

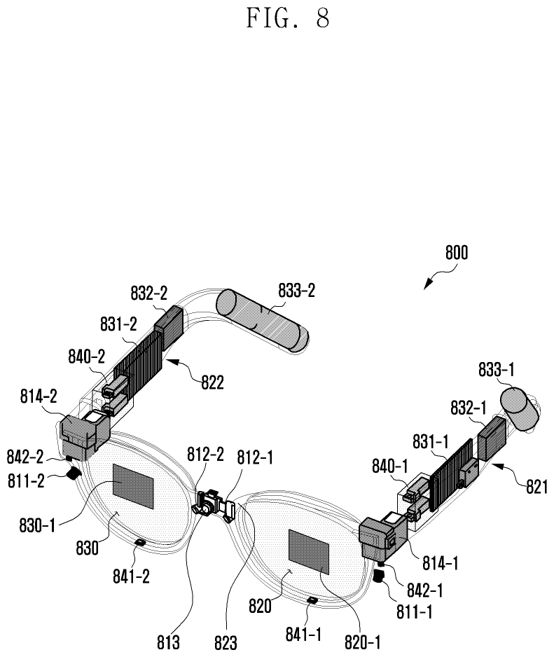

FIG. 8 illustrates the configuration of an external electronic device 800 (for example, the external electronic device 300 in FIG. 3) according to an embodiment of the disclosure.

In various embodiments, the external electronic device 800 may be configured to be worn on the user's head portion. For example, the external electronic device 800 may be configured as at least one of glasses, goggles, a helmet, or a hat, but is not limited thereto. According to an embodiment, the external electronic device 800 may include multiple transparent members (for example, a first transparent member 820 and/or a second transparent member 830) corresponding to the user's both eyes (for example, left eye and/or right eye), respectively.

The external electronic device 800 may provide the user with images related to an augmented reality (AR) service. According to an embodiment, the external electronic device 800 may project or display virtual objects to the first transparent member 820 and/or the second transparent member 830 such that at least one virtual object appears superimposed on the reality recognized by the user through the first transparent member 820 and/or the second transparent member 830 of the electronic device.

Referring to FIG. 8, the external electronic device 800 according to an embodiment may include a body portion 823, support portions (for example, a first support portion 821 and a second support portion 822), and hinge portions (for example, a first hinge portion 840-1 and a second hinge portion 840-2).

According to various embodiments, the body portion 823 and the support portions 821 and 822 may be operatively connected through the hinge portions 840-1 and 840-2. The body portion 823 may include a portion formed to be cradled on the user's nose at least partially.

According to various embodiments, the support portions 821 and 822 may include support members configured to straddle the user's ears at least partially. The support portions 821 and 822 may include a first support portion 821 cradled on the left ear and/or a second support portion 822 cradled on the right ear.

According to various embodiments, the first hinge portion 840-1 may connect the first support portion 821 and the body portion 823 such that the first support portion 821 can rotate with regard to the body portion 823. The second hinge portion 840-2 may connect the second support portion 822 and the body portion 823 such that the second support portion 822 can rotate with regard to the body portion 823. According to another embodiment, the hinge portions 840-1 and 840-2 of the external electronic device 800 may be omitted. For example, the body portion 823 and the support portions 821 and 822 may be connected directly.

According to various embodiments, the body portion 823 may include at least one transparent member (for example, a first transparent member 820 and a second transparent member 830), at least one display module (for example, a first display module 814-1 and a second display module 814-2), at least one camera module (for example, a front image-capturing camera module 813, an eye-tracking camera module (for example, a first eye-tracking camera module 812-1 and a second eye-tracking camera module 812-2), a gesture camera module (for example, a first gesture camera module 811-1 and a second gesture camera module 811-2), and at least one microphone (for example, a first microphone 841-1 and a second microphone 841-2).

In the case of the external electronic device 800 described with reference to FIG. 8, light generated by the display modules 814-1 and 814-2 may be projected to the transparent members 820 and 830, thereby displaying information. For example, light generated by the first display module 814-1 may be projected to the first transparent member 820, and light generated by the second display module 814-2 may be projected to the second transparent member 830. As light capable of displaying virtual objects is projected to the transparent members 820 and 830 at least partially made of a transparent material, the user may recognize the reality on which virtual objects are superimposed. In this case, the display module 160 described with reference to FIG. 1 may be understood as including the display modules 814-1 and 814-2 and the transparent members 820 and 830 of the external electronic device 800 illustrated in FIG. 8. However, the external electronic device 800 described in the disclosure is not limited to the above-described type of information display. Display modules which may be included in the external electronic device 800 may be changed to display modules including various types of information display methods. For example, if the transparent members 820 and 830 have embedded display panels including light-emitting elements made of a transparent material, information may be displayed without separate display modules (for example, a first display module 814-1 and a second display module 814-2). In this case, the display module 160 described with reference to FIG. 1 may refer to the transparent members 820 and 830 and the display panels included in the transparent members 820 and 830.

According to various embodiments, virtual objects output through the display modules 814-1 and 814-2 may include information related to application programs executed by the external electronic device 800 and/or information related to external objects positioned in the actual space which the user recognizes through the transparent members 820 and 830. The external objects may include things existing the actual space. The actual space which the user recognizes through the transparent members 820 and 830 will hereinafter be referred to as the user's field of view (FoV) region. For example, the external electronic device 800 may identify external objects included in at least a part of the region deemed to be the user's FoV from image information related to the actual space acquired through the camera module (for example, the image-capturing camera module 813) of the external electronic device 800. The external electronic device 800 may output virtual objects related to the identified external objects through the display modules 814-1 and 814-2.

According to various embodiments, the external electronic device 800 may display virtual objects related to the AR service together, based on image information related to the actual space acquired through the image-capturing camera module 813 of the external electronic device 800. According to an embodiment, the external electronic device 800 may display virtual objects, based on display modules disposed so as to correspond to the user's both eyes (for example, a first display module 814-1 corresponding to the left eye and/or a second display module 814-2 corresponding to the right eye). According to an embodiment, the external electronic device 800 may display virtual objects, based on preconfigured configuration information (for example, resolution, frame rate, brightness, and/or display region).

According to various embodiments, the transparent members 820 and 830 may include light-collecting lenses (not illustrated) and/or waveguides (for example, a first waveguide 820-1 and/or a second waveguide 830-1). For example, the first waveguide 820-1 may be partially positioned in the first transparent member 820, and the second waveguide 830-1 may be partially positioned in the second transparent member 830. Light emitted from the display modules 814-1 and 814-2 may be incident onto one surface of the transparent members 820 and 830. The light incident onto one surface of the transparent members 820 and 830 may be transferred to the user through the waveguides 820-1 and 830-1 positioned in the transparent members 820 and 830. The waveguides 820-1 and 830-1 may be made of glass, plastic, or polymer, and may include a nanopattern formed on one surface inside or outside the same. For example, the nanopattern may include a grating structure having a polygonal or curved shape. According to an embodiment, the light incident onto one surface of the transparent members 820 and 830 may be propagated or reflected inside the waveguides 820-1 and 830-1 by the nanopattern and then transferred to the user. According to an embodiment, the waveguides 820-1 and 830-1 may include at least one from among at least one diffractive element (for example, diffractive optical element (DOE) or holographic optical element (HOE)) or reflective element (for example, reflective mirror). According to an embodiment, the waveguides 820-1 and 830-1 may guide light emitted from the display modules 814-1 and 814-2 to the user's eyes by using the at least one diffractive element or reflective element.

According to various embodiments, the external electronic device 800 may include an image-capturing camera module 813 (for example, an RGB camera module) for capturing images corresponding to the user's field of view (FoV) and/or measuring the distance from objects, eye-tracking camera modules 812-1 and 812-2 for identifying the direction in which the user gazes, and/or gesture camera modules 811-1 and 811-2 for recognizing a predetermined space. For example, the image-capturing camera module 813 may capture images in the forward direction of the external electronic device 800, and the eye-tracking camera modules 812-1 and 812-2 may capture images in the opposite direction to the image capture direction of the image-capturing camera module 813. For example, the first eye-tracking camera module 812-1 may capture a partial image of the user's left eye, and the second eye-tracking camera module 812-2 may capture a partial image of the user's right eye. According to an embodiment, the image-capturing camera module 813 may include a camera module having a high resolution such as a high-resolution (HR) camera module and/or a photo video (PV) camera module. According to an embodiment, the eye-tracking camera modules 812-1 and 812-2 may detect the user's pupils, thereby detecting the gazing direction. The tracked gazing direction may be used to move the center of a virtual image including a virtual object so as to correspond to the gazing direction. According to an embodiment, the gesture camera modules 811-1 and 811-2 may sense a user gesture within a preconfigured distance (for example, a predetermined space) and/or a predetermined space. The gesture camera modules 811-1 and 811-2 may include a camera module including a global shutter (GS). For example, the gesture camera modules 811-1 and 811-2 may include a GS capable of reducing the rolling shutter (RS) phenomenon, in order to detect and track micro-movements such as fast hand movements and/or fingers.

According to various embodiments, the external electronic device 800 may sense an eye corresponding to the dominant eye and/or the non-dominant eye, between the left eye and/or the right eye, by using at least one camera module 811-1, 811-2, 812-1, 812-2, or 813. For example, the external electronic device 800 may sense an eye corresponding to the dominant eye and/or the non-dominant eye, based on the direction in which the use gazes at an external object or a virtual object.

The number and position of the at least one camera module included in the external electronic device 800 illustrated in FIG. 8 (for example, the image-capturing camera module 813, the eye-tracking camera modules 812-1 and 812-2, and/or the gesture camera modules 811-1 and 811-2) may not be limited. For example, the number and position of the at least one camera module (for example, the image-capturing camera module 813, the eye-tracking camera modules 812-1 and 812-2, and/or the gesture camera modules 811-1 and 811-2) may be variously changed, based on the configuration (for example, shape or size) of the external electronic device 800.

According to various embodiments, the external electronic device 800 may include at least one illumination light emitting diode (LED) (for example, a first illumination LED 842-1 and a second illumination LED 842-2) for improving the accuracy of the at least one camera module (for example, the image-capturing camera module 813, the eye-tracking camera modules 812-1 and 812-2, and/or the gesture camera modules 811-1 and 811-2). For example, the first illumination LED 842-1 may be disposed on a portion corresponding to the user's left eye, and the second illumination LED 842-2 may be disposed on a portion corresponding to the user's right eye. In an embodiment, the illumination LEDs 842-1 and 842-2 may be used as auxiliary means for improving the accuracy when capturing images of the user's pupils by the eye-tracking camera modules 812-1 and 812-2, and may include IR LEDs which generate light at infrared wavelengths. In addition, the illumination LEDs 842-1 and 842-2 may be used as auxiliary means if it is not easy to detect the subject (image capture target) due to dark environments or mixture and reflection of light from various light sources when images of the user's gestures are captured by the gesture camera modules 811-1 and 811-2.

According to various embodiments, the external electronic device 800 may include microphones for receiving the user's voice and peripheral sounds (for example, a first microphone 841-1 and a second microphone 841-2). For example, the microphones 841-1 and 841-2 may be components included in the audio module 170 in FIG. 1.

According to various embodiments, the first support portion 821 and/or the second support portion 822 may include printed circuit boards (PCBs) (for example, a first PCB 831-1 and a second PCB 831-2), speakers (for example, a first speaker 832-1 and a second speaker 832-2), and/or batteries (for example, a first battery 833-1 and a second battery 833-2).

According to various embodiments, the speakers 832-1 and 832-2 may include a first speaker 832-1 for transferring audio signals to the user's left ear and a second speaker 832-2 for transferring audio signals to the user's right ear. The speakers 832-1 and 832-2 may be components included in the audio module 170 in FIG. 1.

According to various embodiments, the external electronic device 800 may include multiple batteries 833-1 and 833-2, and may supply power to the PCBs 831-1 and 831-2 through a power management module (for example, the power management module 188 in FIG. 1). For example, the multiple batteries 833-1 and 833-2 may be electrically connected to the power management module (for example, the power management module 188 in FIG. 1).

Although the external electronic device 800 has previously been described as a device for displaying AR, the external electronic device 800 may be a device for displaying virtual reality (VR). In this case, the transparent members 820 and 830 may be made of an opaque material such that the user cannot recognize the actual space through the transparent members 820 and 830. In addition, the transparent members 820 and 830 may function as a display module 160. For example, the transparent members 820 and 830 may include display panels for displaying information.

According to various embodiments, the external electronic device 800 may include at least one sensor (for example, a wearing detection sensor, a motion sensor, and a touch sensor) (not illustrated) and a communication module (not illustrated). According to an embodiment, the at least one sensor may sense whether the external electronic device 800 is worn on the user's body, and the direction in which the same is worn. For example, the at least one sensor may include at least one of a proximity sensor and a grip sensor. According to an embodiment, the at least one sensor may sense the amount of change in direction caused by the user's movement. For example, the at least one sensor may include an acceleration sensor (for example, the acceleration sensor 372 in FIG. 3) and a gyro sensor (for example, the gyro sensor 371 in FIG. 3). The acceleration sensor may sense acceleration with regard to three axes, and the gyro sensor may sense angular velocities with regard to three axes.

According to an embodiment, the communication module (not illustrated) (for example, the communication module 390 in FIG. 3) may communicate with the outside wirelessly. For example, the communication module may establish communication with other devices and/or access points (APs) through at least one of an ultra-wideband (UWB) module, a Bluetooth (BT) network, a Bluetooth low energy (BLE) network, a wireless fidelity (Wi-Fi) network, an ANT+ network, a long-term evolution (LTE) network, a 5th generation (5G) network, and a narrowband Internet of things (NB-IoT) network, or a combination of two or more thereof.

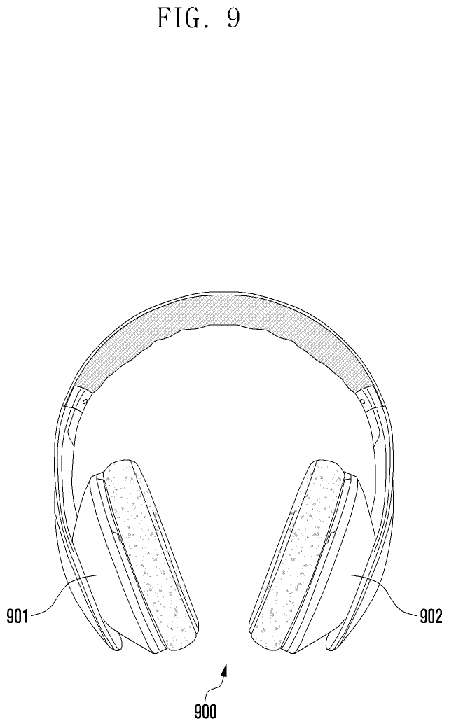

FIG. 9 illustrates the configuration of an external electronic device 900 (for example, the external electronic device 300 in FIG. 3) according to an embodiment of the disclosure.

According to an embodiment, the external electronic device 900 (for example, a headset) may include microphones or speakers. For example, the external electronic device 900 may output sounds through speakers.

According to an embodiment, the external electronic device 900 may be worn on at least a part of the user's body (for example, near the user's left ear or right ear). For example, the external electronic device 900 may be worn on at least a part of the user's body so as to output sounds near the user's ears through speakers.

According to an embodiment, the external electronic device 900 may convert digital signals (for example, digital data) to analog signals (for example, sounds) and output the same.

According to an embodiment, the external electronic device 900 may receive sounds from outside the electronic device through microphones and may generate or store data regarding the received sounds. For example, the external electronic device 900 may generate or convert received sounds to electric data. For example, the external electronic device 900 may convert analog signals to digital signals. For example, the external electronic device 900 may at least temporarily store data regarding sounds.

According to various embodiments, the external electronic device 900 may have various configurations according to the purpose of use by the user, and may provide various functions. The external electronic device 900 may include, for example, a headset, a headphone, an earpiece, hearing aids, or personal sound amplification products.

According to an embodiment, the external electronic device 900 may include a first unit 901 and a second unit 902. For example, the first unit 901 may be worn near the user's right ear, and the second unit 902 may be worn near the user's left ear.

According to various embodiments, the external electronic device 900 may include at least one sensor (for example, a wearing detection sensor, a motion sensor, and a touch sensor) (not illustrated) and a communication module (not illustrated). According to an embodiment, the at least one sensor may sense whether the external electronic device 900 is worn on the user's body, and the direction in which the same is worn. For example, the at least one sensor may include at least one of a proximity sensor and a grip sensor. According to an embodiment, the at least one sensor may sense the amount of change in direction caused by the user's movement. For example, the at least one sensor may include an acceleration sensor (for example, the acceleration sensor 372 in FIG. 3) and a gyro sensor (for example, the gyro sensor 371 in FIG. 3). The acceleration sensor may sense acceleration with regard to three axes, and the gyro sensor may sense angular velocities with regard to three axes.

According to an embodiment, the communication module (not illustrated) (for example, the communication module 390 in FIG. 3) may communicate with the outside wirelessly. For example, the communication module may establish communication with other devices and/or access points (APs) through at least one of an ultra-wideband (UWB) module, a Bluetooth (BT) network, a Bluetooth low energy (BLE) network, a wireless fidelity (Wi-Fi) network, an ANT+ network, a long-term evolution (LTE) network, a 5^{th} generation (5G) network, and a narrowband Internet of things (NB-IoT) network, or a combination of two or more thereof. The UWB module may be positioned on each of the first unit 901 and the second unit 902 of the external electronic device 900.

An electronic device according to various embodiments may include a display, a gyro sensor, an acceleration sensor, a communication module, and a processor. The processor may identify whether an automatic screen rotation function is activated or not, request an external electronic device to provide direction data of the external electronic device related to the degree of rotation of the external electronic device with regard to a designated axis through the communication module, thereby acquiring the direction data, identify the direction of the electronic device related to the degree of rotation of the electronic device with regard to a designated axis, based on values measured by the gyro sensor and the acceleration sensor, determine a user's posture, based on direction data of the electronic device and direction data of the external electronic device, and determine a screen direction mode to be displayed on the display of the electronic device, based on the user's posture.

In the electronic device according to various embodiments, direction data of the external electronic device is data determined by a processor of the external electronic device, based on values measured by a gyro sensor and an acceleration sensor included in the external electronic device.

In the electronic device according to various embodiments, the external electronic device may include a first unit and a second unit, direction data of the external electronic device may be data determined by a processor of a device of the first unit, based on values measured by a gyro sensor and an acceleration sensor included in the first unit, and the processor may acquire direction data of the external electronic device through a communication module included in the first unit.

In the electronic device according to various embodiments, the processor may request the external electronic device to transmit direction data of the external electronic device at a designated timepoint from activation of the automatic screen rotation function of the electronic device to deactivation of the automatic screen rotation function.

In the electronic device according to various embodiments, the processor may determine the user's gaze vector, based on direction data of the external electronic device with reference to a geographic coordinate system.

In the electronic device according to various embodiments, the processor may determine the user's posture, based on the range of a region in which the field of view (FOV) of a gaze vector based on the user's gaze vector and the FOV of the electronic device based on direction data of the electronic device coincide.

In the electronic device according to various embodiments, the processor may determine that the user's posture is a first posture in response to the region in which the FOV of the gave vector and the FOV of the electronic device coincide being in a first range, and may determine that the user's posture is a second posture in response to the region in which the FOV of the gave vector and the FOV of the electronic device coincide being in a second range.

In the electronic device according to various embodiments, the gaze vector and direction data of the electronic device may be based on an Euler angle format indicating the degree of rotation with reference to axes of a coordinate system of the electronic device.

In the electronic device according to various embodiments, the processor may determine that the screen direction mode is a vertical mode in response to the user's posture being determined as a first posture, and may determine that the screen direction mode is a horizontal mode in response to the user's posture being determined as a second posture.

In the electronic device according to various embodiments, the processor may not change the screen direction mode in response to the direction of the electronic device not being changed, and the gaze vector being changed, after determining the screen direction mode, may change the screen direction mode, based on the user's posture, in response to the direction of the electronic device being changed, and the gaze vector not being changed, and may change the screen direction mode, based on the user's posture, in response to the direction of the electronic device being changed, and the gaze vector being changed.

A method for operating an electronic device according to various embodiments may include an operation of identifying whether an automatic screen rotation function is activated or not, an operation of requesting an external electronic device to provide direction data of the external electronic device related to the degree of rotation of the external electronic device with regard to a designated axis, thereby acquiring the direction data, an operation of identifying the direction of the electronic device related to the degree of rotation of the electronic device with regard to a designated axis, based on values measured by a gyro sensor and an acceleration sensor, an operation of determining a user's posture, based on direction data of the electronic device and direction data of the external electronic device, and an operation of determining a screen direction mode to be displayed on a display of the electronic device, based on the user's posture.

In the method for operating an electronic device according to various embodiments, direction data of the external electronic device may be data determined by a processor of the external electronic device, based on values measured by a gyro sensor and an acceleration sensor included in the external electronic device.

In the method for operating an electronic device according to various embodiments, the external electronic device may include a first unit and a second unit, direction data of the external electronic device may be data determined by a processor of a device of the first unit, based on values measured by a gyro sensor and an acceleration sensor included in the first unit, and the method may include an operation of acquiring direction data of the external electronic device through a communication module included in the first unit.

The method for operating an electronic device according to various embodiments may include an operation of requesting the external electronic device to transmit direction data of the external electronic device at a designated timepoint from activation of the automatic screen rotation function of the electronic device to deactivation of the automatic screen rotation function.

The method for operating an electronic device according to various embodiments may include an operation of determining a gaze vector, based on direction data of the external electronic device with reference to a geographic coordinate system.

The method for operating an electronic device according to various embodiments may include an operation of determining the user's posture, based on the range of a region in which the FOV of a gaze vector based on the user's gaze vector and the FOV of the electronic device based on direction data of the electronic device coincide.

The method for operating an electronic device according to various embodiments may include an operation of determining that the user's posture is a first posture in response to the region in which the FOV of the gave vector and the FOV of the electronic device coincide being in a first range, and an operation of determining that the user's posture is a second posture in response to the region in which the FOV of the gave vector and the FOV of the electronic device coincide being in a second range.

In the method for operating an electronic device according to various embodiments, the gaze vector and direction data of the electronic device are based on an Euler angle format indicating the degree of rotation with reference to axes of a coordinate system of the electronic device.

The method for operating an electronic device according to various embodiments may include an operation of determining that the screen direction mode is a vertical mode in response to the user's posture being determined as a first posture, and an operation of determining that the screen direction mode is a horizontal mode in response to the user's posture being determined as a second posture.

The method for operating an electronic device according to various embodiments may include an operation of not changing the screen direction mode in response to the direction of the electronic device not being changed, and the gaze vector being changed, after determining the screen direction mode, an operation of changing the screen direction mode, based on the user's posture, in response to the direction of the electronic device being changed, and the gaze vector not being changed, and an operation of changing the screen direction mode, based on the user's posture, in response to the direction of the electronic device being changed, and the gaze vector being changed.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
a gyro sensor;
an acceleration sensor;
a communication module;
memory storing one or more computer programs; and
one or more processors communicatively coupled to the display and the memory,
wherein the one or more computer programs include computer-executable instructions that, when executed by the one or more processors individually or collectively, cause the electronic device to:
identify whether an automatic screen rotation function is activated,
request an external electronic device to provide direction data of the external electronic device related to a degree of rotation of the external electronic device with regard to a designated axis through the communication module, thereby acquiring the direction data,
identify a direction of the electronic device related to the degree of rotation of the electronic device with regard to a designated axis, based on values measured by the gyro sensor and the acceleration sensor,
determine a user's posture, based on direction data of the electronic device and direction data of the external electronic device, and
determine a screen direction mode to be displayed on the display of the electronic device, based on the user's posture.

2. The electronic device of claim 1, wherein direction data of the external electronic device is data determined by a processor of the external electronic device, based on values measured by a gyro sensor and an acceleration sensor included in the external electronic device.

3. The electronic device of claim 2,
wherein the external electronic device comprises a first unit and a second unit,
wherein direction data of the external electronic device is data determined by a processor of a device of the first unit, based on values measured by a gyro sensor and an acceleration sensor included in the first unit, and
wherein the one or more computer programs further include computer-executable instructions that, when executed by the one or more processors individually or collectively, cause the electronic device to acquire direction data of the external electronic device through a communication module included in the first unit.

4. The electronic device of claim 1, wherein the one or more computer programs further include computer-executable instructions that, when executed by the one or more processors individually or collectively, cause the electronic device to request the external electronic device to transmit direction data of the external electronic device at a designated timepoint from activation of the automatic screen rotation function of the electronic device to deactivation of the automatic screen rotation function.

5. The electronic device of claim 2, wherein the one or more computer programs further include computer-executable instructions that, when executed by the one or more processors individually or collectively, cause the electronic device to determine a gaze vector of the user, based on direction data of the external electronic device with reference to a geographic coordinate system.

6. The electronic device of claim 5, wherein the one or more computer programs further include computer-executable instructions that, when executed by the one or more processors individually or collectively, cause the electronic device to determine the user's posture, based on a range of a region in which a field of view (FOV) of a gaze vector based on the gaze vector of the user and the FOV of the electronic device based on direction data of the electronic device coincide.

7. The electronic device of claim 6, wherein the one or more computer programs further include computer-executable instructions that, when executed by the one or more processors individually or collectively, cause the electronic device to:
determine that the user's posture is a first posture in response to the region in which the FOV of the gaze vector and the FOV of the electronic device coincide being in a first range; and
determine that the user's posture is a second posture in response to the region in which the FOV of the gaze vector and the FOV of the electronic device coincide being in a second range.

8. The electronic device of claim 7, wherein the gaze vector and direction data of the electronic device are based on an Euler angle format indicating the degree of rotation with reference to axes of a coordinate system of the electronic device.

9. The electronic device of claim 7, wherein the one or more computer programs further include computer-executable instructions that, when executed by the one or more processors individually or collectively, cause the electronic device to:
determine that the screen direction mode is a vertical mode in response to the user's posture being determined as a first posture; and
determine that the screen direction mode is a horizontal mode in response to the user's posture being determined as a second posture.

10. The electronic device of claim 9, wherein the one or more computer programs further include computer-executable instructions that, when executed by the one or more processors individually or collectively, cause the electronic device to:
not change the screen direction mode in response to the direction of the electronic device not being changed, and the gaze vector being changed, after determining the screen direction mode;
change the screen direction mode, based on the user's posture, in response to the direction of the electronic device being changed, and the gaze vector not being changed; and
change the screen direction mode, based on the user's posture, in response to the direction of the electronic device being changed, and the gaze vector being changed.

11. A method of operating an electronic device, the method comprising:
identifying whether an automatic screen rotation function is activated;
requesting an external electronic device to provide direction data of the external electronic device related to a degree of rotation of the external electronic device with regard to a designated axis, thereby acquiring the direction data;
identifying a direction of the electronic device related to the degree of rotation of the electronic device with regard to a designated axis, based on values measured by a gyro sensor and an acceleration sensor;
determining a user's posture, based on direction data of the electronic device and direction data of the external electronic device; and
determining a screen direction mode to be displayed on a display of the electronic device, based on the user's posture.

12. The method of claim 11, wherein direction data of the external electronic device is data determined by a processor of the external electronic device, based on values measured by a gyro sensor and an acceleration sensor included in the external electronic device.

13. The method of claim 12,
wherein the external electronic device comprises a first unit and a second unit,
wherein direction data of the external electronic device is data determined by a processor of a device of the first unit, based on values measured by a gyro sensor and an acceleration sensor included in the first unit, and
wherein the method comprises acquiring direction data of the external electronic device through a communication module included in the first unit.

14. The method of claim 12, comprising:
determining a gaze vector, based on direction data of the external electronic device with reference to a geographic coordinate system.

15. The method of claim 14, comprising:
determining the user's posture, based on a range of a region in which a field of view (FOV) of a gaze vector based on a gaze vector of the user and the FOV of the electronic device based on direction data of the electronic device coincide.

16. The method of claim 15, comprising:
determining that the user's posture is a first posture in response to the region in which the FOV of the gaze vector and the FOV of the electronic device coincide being in a first range; and
determining that the user's posture is a second posture in response to the region in which the FOV of the gaze vector and the FOV of the electronic device coincide being in a second range.

17. The method of claim 16, wherein the gaze vector and direction data of the electronic device are based on an Euler angle format indicating the degree of rotation with reference to axes of a coordinate system of the electronic device.

18. The method of claim 16, comprising
determine that the screen direction mode is a vertical mode in response to the user's posture being determined as a first posture; and
determine that the screen direction mode is a horizontal mode in response to the user's posture being determined as a second posture.

19. One or more non-transitory computer-readable storage media storing one or more computer programs including computer-executable instructions that, when executed by one or more processors of an electronic device individually or collectively, cause the electronic device to perform operations, the operations comprising:
identifying whether an automatic screen rotation function is activated;
requesting an external electronic device to provide direction data of the external electronic device related to a degree of rotation of the external electronic device with regard to a designated axis through a communication module, thereby acquiring the direction data;
identifying a direction of the electronic device related to the degree of rotation of the electronic device with regard to a designated axis, based on values measured by a gyro sensor and an acceleration sensor;
determining a user's posture, based on direction data of the electronic device and direction data of the external electronic device; and
determining a screen direction mode to be displayed on the display of the electronic device, based on the user's posture.

20. The one or more non-transitory computer-readable storage media of claim 19, wherein direction data of the external electronic device is data determined by a processor of the external electronic device, based on values measured by a gyro sensor and an acceleration sensor included in the external electronic device.
